(19) United States
(12) Patent Application Publication
(10) Pub. No.: US 2025/0239002 A1
(43) Pub. Date: Jul. 24, 2025

(54) Technique for Optical Property per Sampling Point Medical Image Rendering

(71) Applicant: Siemens Healthineers AG, Forchheim (DE)

(72) Inventor: Kaloian Petkov, Lawrenceville, NJ (US)

(21) Appl. No.: 18/966,448

(22) Filed: Dec. 3, 2024

(30) Foreign Application Priority Data
Jan. 19, 2024 (EP) 24152768.8

(51) Int. Cl. G06T 15/08; G06T 5/70; G06T 7/00; G06T 7/11; G06T 19/20

(52) U.S. Cl. CPC G06T 15/08; G06T 5/70; G06T 7/0012; G06T 7/11; G06T 19/20; G06T 2207/20092; G06T 2207/20132; G06T 2207/30004; G06T 2210/41; G06T 2219/2016

(57) ABSTRACT

A technique for volume rendering, and/or surface rendering, of a medical imaging data set based on optical properties per sampling points is provided. An uncertainty indicator per voxel, and/or per surface element, in relation to a segmentation mask of, and/or an anatomical structure comprised in, a medical imaging data set is received. A randomization of one or more sampling points is scaled based on the received uncertainty indicator, and at least one optical property per sampling point is determined. A volume based on the voxels, and/or a surface based on the surface elements is rendered. The rendering is based on the determined at least one optical property per sampling point.

### RELATED APPLICATION

This application claims the benefit of EP 24152768.8, filed on Jan. 19, 2024, which is hereby incorporated by reference in its entirety.

### FIELD

The present document relates to a technique for volume rendering, and/or surface rendering, of a medical imaging data set based on optical properties per sampling points, in particular including a method, a computing device, a system including the computing device, and a computer program product.

### BACKGROUND

Modern artificial intelligence (AI)-based segmentation tools are revolutionizing the way a physician interacts with imaging data across many clinical and education applications. However, high performance and high-quality three-dimensional (3D) volume rendering that leverages the binary masks produced from such algorithms remains a challenge, especially in real-time imaging modalities and for image-based guidance applications. Fast rendering algorithms often result in distracting visual artifacts at the boundaries of segmentation classes, which may impede the spatial understanding of the physician. Impeding the spatial understanding may in turn impair a successful treatment planning and/or execution.

Smooth rendering with binary segmentation masks may first use a smoothed distance transform on the binary volume to compute a signed distance field, whose zero (0) levelset may be rendered as an isosurface. Other image smoothing operations may be applied as well, including specialized interpolation approaches, and smooth surface extraction. While such conventional approaches can produce high quality results, they require additional pre-processing leading to undesirable latencies, in particular making them unsuitable for realtime applications.

### SUMMARY AND DETAILED DESCRIPTION

It is therefore an object to provide a solution for high performance rendering of medical image data, for reducing latencies, in particular due to pre-processing, and/or for avoiding disruptive changes to the rendering pipeline. The solution provided herewith should be usable for interventional image-guided procedures, e.g., surgical image-guided procedures.

This object is solved by a method for volume rendering, and/or surface rendering, of a medical imaging data set based on optical properties per sampling points, by a computing device, by a system including the computing device, and by a computer program (and/or computer program product). Advantageous aspects, features and embodiments are described in the claims and in the following description together with advantages.

In the following, the solution is described with respect to the method for volume rendering, and/or surface rendering, of a medical imaging data set based on optical properties per sampling points as well as with respect to the computing device. Features, advantages, or alternative embodiments herein can be assigned to the other claimed objects (e.g., the system, the computer program, or a computer program product), and vice versa. In other words, claims for the computing device, and/or the system including the computing device, can be improved with features described or claimed in the context of the methods. In this case, the functional features of the method are embodied by structural units of the system and vice versa, respectively.

As to a method aspect, a computer-implemented method for volume rendering, and/or surface rendering, of a medical imaging data set based on optical properties per sampling points is provided. The method includes an act of receiving an uncertainty indicator per voxel, and/or per surface element, in relation to a segmentation mask of, and/or an anatomical structure included in, a medical imaging data set. The method further includes an act of scaling a randomization of one or more sampling points based on the received uncertainty indicator. Optionally, the scaling of the randomization may include scaling a distance to a sample center as a function of the received uncertainty indicator. The function may include a linear dependence.

The method further includes an act of determining at least one optical property per sampling point.

The at least one optical property may be derived from a medical scanner output by a transfer function which, e.g., in the case of a computed tomography (CT) scanner maps Hounsfield units (HU) to optical color and optical opacity (e.g., by a one-dimensional, 1D transfer function). Higher-order transfer functions may have further inputs, e.g., data gradient, and/or curvature. E.g., the mapping may be set by an algorithm, may use procedure-specific presets, may be set by user interactions, or combinations of these methods.

The method still further includes an act of rendering the volume based on the voxels, and/or the surface based on the surface elements. The rendering is based on the determined at least one optical property per sampling point.

By the technique, a high performance and high quality three-dimensional (3D) volume rendering, and/or a surface rendering of medical imaging data sets, are enabled, which can avoid visual artefacts, in particular at boundaries of anatomical structures and/or of segmentation classes. Alternatively, or additionally, disruptive changes of the rendered volume and/or the rendered surface can be avoided. A spatial understanding of the rendered volume and/or the rendered surface can be improved for a medical practitioner (e.g., a physician, a radiologist and/or a surgeon). Further alternatively, or additionally, the technique can dispense with a need for complex pre-processing and/or facilitate avoiding latencies. The technique is, in particular, combinable with real-time medical imaging, e.g., for medical image-based guidance (e.g., during surgical intervention and/or endoscopy).

The uncertainty indicator (also: uncertainty value) may include a value of an (e.g., uncertainty) metric and/or an estimated value. The (e.g., uncertainty) value may represent a confidence in a label prediction, e.g., from a deep neural network-based segmentation algorithm, the subjective confidence in a manual segmentation of a practitioner, and/or a value derived from the data, e.g., a signal-to-noise (e.g., SNR) measurement.

The uncertainty indicator (and/or, e.g., uncertainty, value) may be derived (e.g., computed) or received for all voxels or subsets of voxels, e.g., near the boundary of a segmented object or for the voxels belonging to a label and/or segmentation mask.

E.g., the (in particular, uncertainty) metric may have values in the range between zero and one (and/or [0,1]), with zero corresponding to no uncertainty and one corresponding to maximal uncertainty.

The method may make use of (in particular, one or more) sampling points. The sampling points may be randomized.

The randomization may include those positions of the sampling points (also: sampling locations and/or sampling positions) used for computing the volume rendering integral along viewing rays being offset in a randomized direction. The offset magnitude may be proportional to the uncertainty indicator (also: in particular, local, uncertainty value).

For sampling locations with well-defined local surfaces (e.g., with a large voxel gradient magnitude), the randomization may be constrained to the plane perpendicular to the surface normal and/or to the voxel gradient. With weakly defined local surfaces (e.g., with a voxel gradient magnitude below a predetermined threshold), the sampling position offset may include (or may be a) weighted average of the volume-based and/or surface-based randomization, with the weighting proportional to the voxel gradient magnitude.

Randomized locations may (e.g., always) be determined (e.g., computed) on both the plane perpendicular to the voxel gradient and within a box or sphere around the voxel. The two types of randomized locations may (e.g., always) be averaged with weighting based on the gradient magnitude. If the gradient magnitude is large, e.g., near the surface of a bone, the planar sampling may be the primary or only contributor to the weighted average.

The voxel gradient may be (or may correspond to) the vector in the direction of the largest change in scalar data (e.g., including opacity, color, reflectance, one or more values indicative of a chromatic scattering, HU values, and/or CT numbers). The voxel gradient magnitude may indicate the amount of change in the scalar data. The magnitude may be high at the interface between tissue types, e.g., bone and muscle, and low within a single tissue type. Alternatively, or additionally, a large gradient magnitude may indicate that the location around the voxel may behave more like a surface in the context of physical processes or rendering, e.g., in relation to light scattering.

The use of the uncertainty indicator for scaling the randomization of one or more sampling points may alternatively be denoted as stochastic sampling and/or as stochastic (in particular, label) volume rendering (and/or surface rendering, in particular, in case of a single sampling point).

For volume rendering, the uncertainty indicator may be received (and/or provided) per voxel. Alternatively, or additionally, for surface rendering, the uncertainty indicator may be received (and/or provided) per surface element (and/or per pixel).

The anatomical structure may include one or more organs, and/or one or more types of body tissues (e.g., soft tissue and/or bone tissue). Any one of the body tissues may be assigned a value on the Hounsfield unit (HU) scale. The HU scale value for computed tomography (CT) as medical imaging modality may be denoted as CT number.

The segmentation mask may include a binary mask per class (also: label). A class may refer to an anatomical structure, like an organ.

A segmentation class, and/or a label, may refer to an anatomical structure (e.g., an organ, such as the liver and/or a kidney).

For surface rendering, the randomization may be scaled for one sampling point. Alternatively, or additionally, for volume rendering, the randomization may be scaled for multiple sampling points.

The at least one optical property may include at least one rendering parameter, in particular a (e.g., tint of an) color or a change thereof, a (e.g., change in an) optical opacity, and/or a combination thereof. Alternatively, or additionally, the at least one optical property may refer to how a location within the volume reacts with light in the context of a rendering algorithm, e.g., how it absorbs and scatters light.

By the scaling of the randomization of the one or more sampling points, at least one parameter (e.g., a segmentation class and/or a HU scale value) per voxel, and/or per surface element, may be modified. This effect may in particular occur at the boundaries between anatomical structures, and/or at the boundaries between segmentation classes, due to the dependence on the uncertainty indicator, the value of which is increased at the boundaries as compared to inside the anatomical structure, and/or inside the segmentation class.

The rendering may be based on a raycasting and/or Monte Carlo path tracing algorithm. Alternatively, or additionally, the rendering may include performing smoothed shading based on the uncertainty indicator and/or on subsurface scattering (SSS).

SSS may be used to perform smoothed surface shading. The uncertainty indicator (also: uncertainty value) may be used to define the scattering parameter, which may be a scatter radius and/or an average path length between scatter events. Larger uncertainty (e.g., according to the uncertainty indicator) may result in light rays leaving the surface farther away from the entry point, which produces a smoothed surface appearance in the final (e.g., rendered and/or displayed) image.

Conventional volume visualization or rendering methods based on raycasting, which are still used in many current advanced visualization medical products, simulate only the emission and absorption of radiant energy along the primary viewing rays through the volumetric data. The emitted radiant energy at each point is absorbed according to the Beer-Lambert law along the ray to the observer location with absorption coefficients derived from the patient data. Renderers (computing devices with an implemented rendering algorithm) typically compute shading, using only the standard local shading models at each point along the ray (e.g., the Blinn-Phong model), based on local volume gradients (i.e., local illumination). While fast, these methods do not simulate the complex light scattering and extinction associated with photorealism (i.e., global illumination).

Monte Carlo path tracing is a global illumination algorithm, which solves the rendering equation using Monte Carlo integration. It can produce highly realistic images, including for medical visualization. At the same time, the computational requirements are very high since hundreds to thousands of discrete light paths need to be simulated at each pixel or voxel. As more and more paths are simulated, the solution converges on an accurate estimation of the irradiance at each point for incoming light from all directions. The renderer employs a hybrid of volumetric scattering and surface-like scattering, modeled by phase functions and bidirectional reflectance distribution functions (BRDFs), respectively, based on properties derived from the anatomical structures. Producing a single image may take of the order of minutes and is thus currently not suitable for real-time rendering. A variety of algorithms aim at addressing the performance challenges, including irradiance caching, which requires a long pre-computation on lighting changes before real-time rendering is possible, artificial intelligence (AI)-based denoising, and light path generation. However, real-time rendering still remains unachievable with conventional Monte Carlo path tracing.

The rendering may further use a smoothed distance transform and/or a signed distance field (SDF). Alternatively, or additionally, the rendering may further make use of interpolation and/or smooth surface extraction.

The act of rendering may include displaying the volume and/or the surface using a screen, a stereoscopic display, a virtual reality (VR) display, and/or an augmented reality (AR) headset.

The received uncertainty indicator may be based on a noise measurement within a local neighbourhood within a segmentation mask and/or across segmentation masks, and/or within an anatomical structure and/or across anatomical structures. Optionally, the noise measurement may include determining a signal-to-noise ratio (SNR), a peak signal-to-noise ratio (PSNR), and/or a contrast-to-noise ratio (CNR). Alternatively, or additionally, the noise measurement may include determining a signal-to-interference-and-noise ratio (SINR) and/or a carrier-to-noise-and-interference ratio (CNIR).

A noise measurement may provide a higher value (e.g., of noise) with an increasing number of label values (and/or segmentation classes). Alternatively, or additionally, a low measured SNR may imply high noise in the neighbourhood of the sample, which may be associated with high uncertainty in a segmentation (and/or color tinting of anatomical structures). A high SNR may imply a strong signal, and in this case, a more certain segmentation. Further alternatively, or additionally, a high noise measurement may be associated with high uncertainty and/or a large number of unique voxel classes and/or label values in the local neighbourhood of the sample.

In areas of high frequency and/or large overlap between segmentation masks, and/or between anatomical structures, voxel and/or surface elements, have a high uncertainty, e.g., corresponding to a high value of the uncertainty indicator.

The high frequency may refer to a changing of details of the medical imaging data included in the medical imaging data set, in particular, in terms of signal processing performed in the frequency domain and/or using a (in particular fast) Fourier transformation (in particular an FFT). Alternatively, or additionally, a high frequency may be indicative of, and/or may include, a sharp transition among labels.

The received uncertainty indicator may be determined by a segmentation algorithm, which provides a segmentation mask.

The uncertainty indicator, e.g., based on a noise measurement, may be (e.g., routinely) determined when the segmentation of the medical imaging data included in the medical imaging data set is performed.

E.g., the act of receiving the uncertainty indicator may include (e.g., simultaneously) receiving the segmentation mask.

The scaling of the randomization may include scaling a distance to a sample center as a function of the received uncertainty indicator. The function may include a linear dependence.

The distance to the sample center may include a distance along a ray, may include a movement along a random direction, and/or may be determined by a size of a box.

Computing the volume rendering integral along a viewing ray requires sampling the optical properties of the volume at a specific set of locations (e.g., points at regular intervals along the viewing ray).

For each sampling location, the location in (e.g., 3D) space may be perturbed based on the uncertainty indicator (and/or uncertainty value) so that for areas with high uncertainty, averaging the values over a larger local neighbourhood is performed when Monte Carlo integration is used. The same process may be applied many times.

The scaling of the randomization may parameterize how the uncertainty indicator (and/or uncertainty value) is tied to the rendering.

E.g., in practical terms, the perturbation may be applied by creating a sphere and/or an axis-aligned bounding box (AABB), where the radius, and/or the diameter, are proportional to the uncertainty indicator (and/or uncertainty value). A random point inside the sphere and/or the AABB may be picked as the sampling location.

Alternatively, or additionally, the unit sphere and/or unit AABB may be sampled at the sample location and the distance scaled to the original sample center based on the uncertainty indicator (and/or uncertainty value).

For locations with well-defined local surfaces (e.g., having a large voxel gradient magnitude), the randomization may be constrained to the plane perpendicular to the surface normal and/or to the voxel gradient, in which case points are picked in a disk and/or rectangle on the perpendicular plane. Alternatively, or additionally, with weakly defined local surfaces (e.g., having a voxel gradient magnitude below a predetermined threshold), the sampling position offset may include (or may be) a weighted average of the volume-based and/or surface-based randomization, in particular, with the weighting proportional to the voxel gradient magnitude.

E.g., when the (e.g., voxel) gradient magnitude is small, the weight for a surface-like location randomization may be small and the weight for a volume-like location randomization may be large.

In the context of weighted averaging, only the relative magnitudes of the weights may matter since they may be (e.g., always) normalized to sum up to 1.

The method may further include an act of combining the optical properties of the more than one sampling points. The rendering may be based on the combined at least one optical property of the more than one sampling points.

The combining may be performed for the case of more than one sampling points, in particular, for volume rendering. Alternatively, or additionally, the combining may include determining an (e.g., weighted) average of the optical properties (e.g., color and/or opacity per voxel).

By the combining, a smooth rendering of the segmentation mask, and/or of the anatomical structures, is facilitated.

The rendering may include a denoising. Optionally, the denoising may include using random number generator (RNG) sequences for sampling the medical imaging data included in the medical imaging data set.

The rendering may be repeated (and/or performed multiple times) with a different seed for the random number generation algorithm (and/or with changed randomization).

The RNG sequence may include a very large sequence of (e.g., millions and/or billions) of random numbers, e.g., within the interval between zero and one (and/or [0,1]), such as values of 0.01 (and/or 1/100), and/or 0.1 (and/or 1/10).

A randomized location (e.g., of the sampling point) may be independent, in particular by definition, and/or per voxel and/or per surface element (and/or pixel). Alternatively, or additionally, each time a sampling location is determined, a (in particular independent and/or different) randomized offset may be applied.

The technique may use three types of sampling. The first type of sampling is the sampling of the volume optical properties along a ray to compute the volume rendering integral. The sampling location offsets according to the technique are applied to these samples.

The second type of sampling is to sample each pixel in the final image multiple times to reduce the noise from the randomized offsets. Alternatively, or additionally, statistical and/or AI-based denoising methods may be used. This sampling may, in particular, be used with volume rendering algorithms based on ray casting.

Concerning the third type of sampling, when using Monte Carlo integration for photorealistic volume rendering, the individual light paths from each pixel through the volume are sampled. The rendering process is repeated many times, and the results are averaged as in the raycasting case. Statistical and/or AI-based denoising methods may further be used to reduce the image variance faster.

The medical imaging data set may be acquired by a medical scanner. The medical scanner may include an X-ray device, an ultrasound (US) device, a positron emission tomography (PET,) device, a computed tomography (CT) device, a single-photon emission computed tomography (SPECT) device, and/or a magnetic resonance tomography (MRT) device.

The volumetric rendering may, in particular, be performed for a medical imaging data set acquired from the medical scanner.

The at least one optical property may include an opacity, a reflectance, a color, and/or at least one value indicative of a chromatic scattering.

The at least one optical property may, in particular, include a combination of the color and the opacity.

Rendering may include applying a reconstruction filter. The reconstruction filter may include, e.g., a trilinear filter, a cubic B-Spline filter, a nearest neighbour filter, and/or any (in particular other) higher-order reconstruction filter.

The rendering may include ray casting, Monte Carlo path tracing, subsurface scattering (SSS), and/or rendering a color mesh.

SSS may include (and/or may be) a shading effect computed as part of rendering a surface. The surface may be defined explicitly (e.g., as a mesh), and/or implicitly (e.g., as a, in particular, zero, level set, and/or as an isosurface). Alternatively, or additionally, the surface may include a surface of an organ and/or of an anatomical structure.

SSS may simulate the diffusion of light below the surface of the (in particular, segmented) anatomical structure (also: object).

SSS may be used to incorporate uncertainty, to smoothen shading and/or to improve an image quality, in particular while preserving the original surface geometry.

Alternatively, or additionally, a change in a color mesh may be used (e.g., to indicate the uncertainty of assigning a voxel, and/or a surface element, to a segmentation class and/or to an anatomical structure).

The SSS may be controlled by a, in particular, single, radius value. The radius value may be determined based on the received uncertainty indicator.

The radius may determine a distribution of volumes. Alternatively, or additionally, the radius may determine the maximum distance between the light exit point and the light entry point assuming multiple scattering of light below the surface. Further alternatively, or additionally, the radius may determine the size of a disk placed at the light entry position and oriented along the surface normal. Alternatively, or additionally, the “disk normal” may be oriented along the surface normal, in particular, the plane of the disk may be perpendicular to the surface normal. The projection of the disk onto the surface may define a patch, which may be sampled with various statistical methods (e.g., uniform sampling, and/or Poisson sampling) to pick a light exit location.

The received uncertainty indicator may be mapped to at least one property of the SSS. In particular, a subsurface attenuation of one or more wavelength bands may be modulated according to the received uncertainty indicator. E.g., a radius of a patch for SSS sampling may be changed by different amounts based on both the uncertainty (e.g., according to the uncertainty indicator) and color wavelength. As a result, the shading in areas of high uncertainty may both become smoother and may pick up a (e.g., red) subsurface tint.

Alternatively, or additionally, physically-based rendering of the SSS effect may use an average path length between scatter events (e.g., instead of a radius).

A different (and/or independent) radius may be used for each color channel. E.g., SSS for a human skin material may use a larger radius for the red channel scattering to simulate blood flow below the skin surface (e.g., as compared to the radii of the green and blue channels). The uncertainty handling may use different scaling of the radius for each color channel based on a material profile.

Whenever the word “radius” is used, the same may apply to a diameter (e.g., of a disk and/or a box).

Alternatively, or additionally, a (e.g., local) surface patch may be determined around a (e.g., sampling) point, where a light ray enters the surface.

A segmentation mesh (e.g., representing the segmentation mask and/or the anatomical structure) may be determined by a (e.g., neural) Marching Cube algorithm, and/or a Marching Tetrahedra algorithm.

The Marching Cube algorithm may include a computer graphics algorithm for extracting a polygonal mesh (in particular, of an isosurface) from a 3D discrete scalar field, the elements of which are the voxels). The applications of this algorithm may be mainly concerned with medical visualizations such as CT and/or MRT medical imaging data sets, and special effects or 3D modelling with metaballs, or other metasurfaces. The Marching Cubes algorithm may be meant to be used for 3D (in particular, for volume rendering). A 2D version of this algorithm (e.g., for surface rendering) may be called the marching squares algorithm.

The Marching Cube algorithm may proceed through the scalar field (and/or the voxels), taking eight neighbor locations at a time (thus forming an imaginary cube), then determining the one or more polygons needed to represent the part of the isosurface that passes through this cube. The individual polygons may then be fused into the desired surface.

Fusing may be done by creating an index to a precalculated array of 256 possible polygon configurations (2⁸⁼²⁵⁶) within the cube, and/or by treating each of the 8 scalar values as a bit in an 8-bit integer. If the scalar's value is higher than the iso-value (e.g., it is inside the surface), the appropriate bit may be set to one, while if it is lower (e.g., outside), it may be set to zero. The final value, after all eight scalars are checked, may be the actual index to the polygon indices array.

Each vertex of the generated polygons may be placed on the appropriate position along the cube's edge by linearly interpolating the two scalar values that are connected by that edge.

The gradient of the scalar field at each grid point (and/or sampling point) may be (and/or may correspond to) also the normal vector of a hypothetical isosurface passing from that point. Therefore, these normals may be interpolated along the edges of each cube to find the normals of the generated vertices, which may be essential for shading the resulting mesh with some illumination model.

Marching tetrahedra may include an algorithm in the field of computer graphics to render implicit surfaces and may be viewed as a generalization of the Marching Cube algorithm.

In the Marching Tetrahedra algorithm, each cube may be split into six irregular tetrahedra by cutting the cube in half three times, and/or cutting diagonally through each of the three pairs of opposing faces. In this way, the tetrahedra all share one of the main diagonals of the cube. Instead of the twelve edges of the cube, there are nineteen edges: the original twelve, six face diagonals, and the main diagonal. Just like in the Marching Cubes algorithm, the intersections of these edges with the isosurface may be approximated by linearly interpolating the values at the grid points (and/or sampling points).

Adjacent cubes may share all edges in the connecting face, including the same diagonal. This is an important property to prevent cracks in the rendered surface, because interpolation of the two distinct diagonals of a face usually gives slightly different intersection points. An added benefit is that up to five computed intersection points may be reused when handling the neighbor cube. This includes the computed surface normals and/or other graphics attributes at the intersection points.

Each tetrahedron has sixteen possible configurations, falling into three classes: no intersection, intersection in one triangle, and intersection in two (adjacent) triangles. It is straightforward to enumerate all sixteen configurations and map them to vertex index lists defining the appropriate triangle strips.

The cubical cells to be meshed can alternatively be sliced into five (5) tetrahedra, using a Diamond cubic lattice as a basis. Cubes may be mated on each side with another cube that has an opposite alignment of the tetrahedron around the centroid of the cube. Alternating vertices may have a different number of tetrahedra intersecting on them, resulting in a slightly different mesh depending on position. When sliced this way, additional planes of symmetry may be provided. Having a tetrahedron around the centroid of the cube may also generate very open spaces around points that are outside of the surface.

In the absence of a user interaction (e.g., during a predetermined time period), for the rendering, multiple stochastic passes may be accumulated, and/or averaged, over medical imaging data associated with different sampling points.

The absence of the user interaction (in particular with the renderer) may also be denoted as (in particular performing the rendering) offline.

By accumulating the multiple stochastic passes (and/or averaging over the medical imaging data associated with different sampling points and/or samples), a variance, in particular, due to noise, may be reduced and a quality of the rendered volume may be improved.

The surface rendering with uncertainty-based subsurface scattering (SSS) may (e.g., still) use a stochastic process for the rendering, and/or (e.g., still) need multiple passes to reduce the variance and/or noise (e.g., even though only using one sampling point), in particular, like the volume rendering.

Alternatively, or additionally, there exist rendering techniques that can produce approximate SSS without stochastic sampling, e.g., screen-space techniques, which may be suitable for interactive rendering, while the more complex method (e.g., according to the technique) may be used during offline rendering.

Alternatively, or additionally, in the presence of a user interaction, the rendering may be performed without accumulating multiple stochastic passes, and/or without averaging, over medical imaging data associated with different sampling points. Optionally, after a predetermined time period, in which no user interaction is received, multiple stochastic passes may be accumulated, and/or averaged, over medical imaging data associated with different sampling points.

The user interaction may be received by a user interface (UI), in particular a graphical user interface (GUI). The user interaction may, e.g., include, rotating the rendered volume.

The presence of the user interaction (in particular, with the renderer) may also be denoted as (in particular, performing the rendering) online and/or in realtime.

By skipping the accumulating of the multiple stochastic passes, and/or skipping the averaging, noisy medical imaging data may be rendered during the user interaction.

Alternatively, or additionally, an interactive reconstruction of Monte Carlo image sequences may make use of a recurrent denoising autoencoder.

Further alternatively, or additionally, a temporal reprojection may be used.

The recurrent denoising autoencoder may combine spatial and temporal denoising, using Monte Carlo samples from the current and previous frames.

Alternatively, or additionally, temporal reprojection may be used explicitly to map pixels from previously rendered images to the current image for weighted blending. If the previous image is rendered offline with high quality, blending pixels from the previous image may increase the quality compared to only denoising the interactive image.

The rendering may include rendering an inhomogeneous representation of the volume, and/or of the surface, including at least partially a segmentation mask and at least partially a (in particular tinted or colored or shaded or marked) anatomical structure, preferably according to a selected HU scale value (e.g., for, in particular specifically, rendering soft tissue or bone tissue).

The rendered volume may be displayed by a display device. The display device may include a (e.g., computer) screen, a projector (e.g., onto a surface in a, in particular operating, room, and/or onto a patient), and/or a virtual reality (VR, and/or augmented reality, AR, and/or extended reality, XR) headset.

The segmentation may only be performed for selected organs (and/or selected anatomical structures) within the medical imaging data set.

The computer-implemented method may make use of deep learning (DL).

As to a device aspect, a computing device (computer or processor) for volume rendering, and/or surface rendering, of a medical imaging data set based on optical properties per sampling points is provided. The computing device includes a receiving module (instructions) configured for receiving an uncertainty indicator per voxel, and/or per surface element, in relation to a segmentation mask of, and/or an anatomical structure included in, a medical imaging data set. The computing device includes a scaling module configured for scaling a randomization of one or more sampling points based on the received uncertainty indicator. Optionally, the scaling of the randomization may include scaling a distance to a sample center as a function of the received uncertainty indicator.

The computing device further includes a determining module configured for determining at least one optical property per sampling point. The computing device still further includes a rendering module (renderer or graphics processing unit) configured for rendering the volume based on the voxels, and/or the surface based on the surface elements. The rendering is based on the determined at least one optical property per sampling point.

Optionally, the computing device may include a combining module configured for combining the optical properties of the more than one sampling points. The rendering may be based on the combined at least one optical property of the more than one sampling points.

The computing device may be configured to perform any one of the acts of the method, and/or include any one of the features, described in the context of the method aspect.

As to a system aspect, a system for volume rendering, and/or surface rendering, of a medical imaging data set based on optical properties per sampling points is provided. The system includes a medical scanner configured for providing a medical imaging data set. The system further includes a computing device according to the device aspect. The receiving module of the computing device is configured for receiving the uncertainty indicator per voxel, and/or per surface element, in relation to the segmentation mask of, and/or the anatomical structure included in, the medical imaging data set provided by the medical scanner.

As to a further aspect, a computer program product is provided. The computer program product includes program elements (instructions), which induce a computing device (e.g., the computing device according to the device aspect) to carry out the acts of the method for volume rendering, and/or surface rendering, of a medical imaging data set based on optical properties per sampling points according to the method aspect, when the program elements are loaded into a memory of the computing device.

As to a still further aspect, a non-transitory computer-readable medium is provided, on which program elements are stored that can be read and executed by a computing device, to perform acts of the method for volume rendering, and/or surface rendering, of a medical imaging data set based on optical properties per sampling points according to the method aspect, when the program elements are executed by the computing device.

The properties, features and advantages described above, as well as the manner they are achieved, become clearer and more understandable in the light of the following description and embodiments, which will be described in more detail in the context of the drawings.

This following description does not limit the invention on the contained embodiments. Same components or parts can be labeled with the same reference signs in different figures. In general, the figures are not for scale.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

FIG. 1 is a flow chart of a method for volume rendering, and/or surface rendering, of a medical imaging data set based on optical properties per sampling points according to a preferred embodiment;

FIG. 2 is an overview of the structure and architecture of a computing device for volume rendering, and/or surface rendering, of a medical imaging data set based on optical properties per sampling points according to a preferred embodiment, which computing device may be configured for performing the method of FIG. 1;

FIGS. 3A, 3B and 3C show an exemplary visual comparison of using a trilinear voxel reconstruction without and with stochastic label map sampling, and of a cubic B-spline (as an example of a higher order) voxel reconstruction with stochastic label map sampling;

FIGS. 4A, 4B and 4C show a first exemplary close-up of the anatomical structure at the top left in the trilinear voxel reconstruction with stochastic label map sampling of FIG. 3B, with FIG. 4A showing the original, FIG. 4B showing a stochastic sampling, and FIG. 4C showing the accumulated result;

FIGS. 5A, 5B and 5C show a second exemplary close-up of the anatomical structure at bottom right in the trilinear voxel reconstruction with stochastic label map sampling of FIG. 3B, with FIG. 5A showing the original, FIG. 5B showing a stochastic sampling, and FIG. 5C showing the accumulated result;

FIGS. 6A and 6B show an exemplary visual comparison of direct rendering of segmentation meshes obtained via Marching Cubes of a label map smoothing the surface normal only in FIG. 6A, and stochastic SSS smoothing out visual surface artefacts in FIG. 6B; and

FIGS. 7A, 7B, 7C and 7D show a further exemplary visual comparison of a human torso using tinting structures only in FIG. 7A, segmented structures only in FIG. 7B, and zooming-ins to the thorax in FIGS. 7C and 7D.

### DETAILED DESCRIPTION

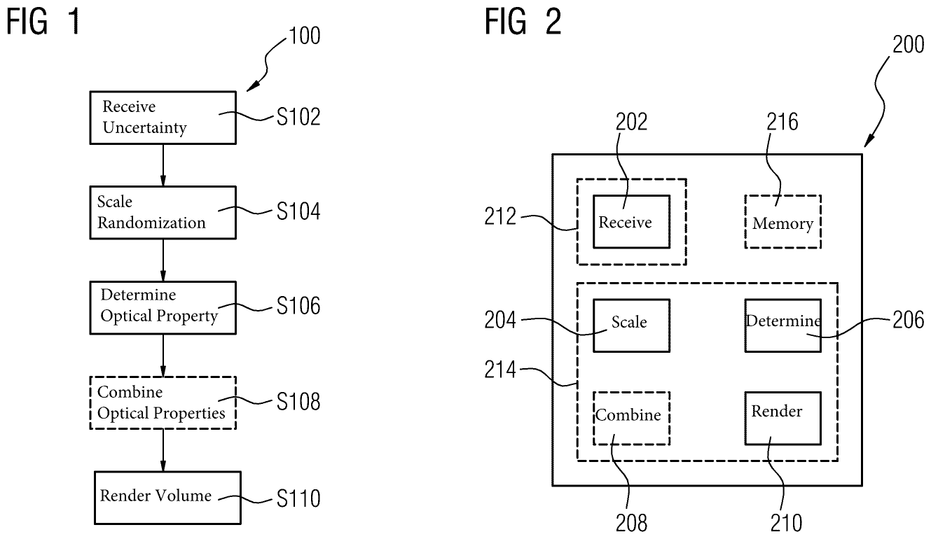

FIG. 1 schematically illustrates an exemplary flowchart for a method of volume rendering, and/or surface rendering, of a medical imaging data set based on optical properties per sampling points. The method is generally referred to by the reference sign 100.

The method 100 includes an act S102 of receiving an uncertainty indicator per voxel, and/or per surface element, in relation to a segmentation mask of, and/or an anatomical structure included in, a medical imaging data set.

The method 100 further includes an act S104 of scaling a randomization of one or more sampling points based on the received uncertainty indicator. Optionally, the scaling S104 of the randomization may include scaling a distance to a sample center as a function of the received S102 uncertainty indicator.

The method 100 further includes an act S106 of determining at least one optical property per sampling point.

The method 100 still further includes an act S110 of rendering the volume based on the voxels, and/or the surface based on the surface elements. The rendering S110 is based on the determined S106 at least one optical property per sampling point.

Optionally, the method 100 may include an act S108 of combining the optical properties of the more than one sampling points. The rendering S110 may be based on the combined S108 at least one optical property of the more than one sampling points.

FIG. 2 schematically illustrates an exemplary architecture of a computing device (computer) for volume rendering, and/or surface rendering, of a medical imaging data set based on optical properties per sampling points. The computing device is generally referred to by the reference sign 200.

The computing device 200 includes a receiving module 202 configured for receiving an uncertainty indicator per voxel, and/or per surface element, in relation to a segmentation mask of, and/or an anatomical structure included in, a medical imaging data set.

The computing device 200 further may include a scaling module 204 configured for scaling a randomization of one or more sampling points based on the received uncertainty indicator. Optionally, the scaling of the randomization may include scaling a distance to a sample center as a function of the received uncertainty indicator.

The computing device 200 further includes a determining module 206 configured for determining at least one optical property per sampling point.

The computing device 200 still further may include a rendering module 210 configured for rendering the volume based on the voxels, and/or the surface based on the surface elements. The rendering is based on the determined at least one optical property per sampling point.

Optionally, the computing device 100 may include a combining module 208 configured for combining the optical properties of the more than one sampling points. The rendering may be based on the combined at least one optical property of the more than one sampling points.

The receiving module 202 may be embodied by an input-output interface 212. Alternatively, or additionally, any one of the scaling module 204, the determining module 206, the rendering module 210, and the optional combining module 208 may be embodied by a processor (e.g., a central processing unit, CPU, and/or a graphics processing unit, GPU). Further alternatively, or additionally, the computing device 200 may include at least one memory 216.

The computing device 200 may be configured for performing the method 100.

A system (not shown) may include the computing device 200 and a medical scanner, which is configured for providing the medical image data set, for which the uncertainty indicator is received.

The system may be configured to perform the method 100.

The technique (e.g., including the method 100, and/or the computing device 200) may also be denoted as high-quality rendering with binary label volumes from segmentation with uncertainty.

The technique can implement high quality rendering for segmentation data (and/or anatomical structures) via stochastic sampling. In a general embodiment, a binary mask per label may be received with the goal to modify a voxel classification, and/or other parameters, per label class for volume rendering (e.g., tinting the optical color and/or changing the optical opacity), visualize the mask directly as colored voxels, and/or visualize the mask directly as a surface. Specific applications may employ different methods per label class. “Different methods” may refer to applying a combination of the techniques listed above in a single rendering based on the segmentation, e.g., tint the voxels covered by the heart mask, lower the opacity of the voxels covered by the ribs mask, and (in particular, simultaneously) render vessels as meshes.

In a first act of an embodiment (e.g., the general embodiment), a per-voxel uncertainty value (and/or uncertainty indicator) is estimated based on a noise measurement within a local neighborhood within each mask and across masks, with voxels in areas of high frequency detail and larger overlap between masks having higher uncertainty. Alternatively, or additionally, an uncertainty metric may be computed as part of the segmentation algorithm and used directly as or in combination with the estimated uncertainty value.

In the embodiment, during rendering, a randomized offset is applied each time the label volume is sampled with the scaling of the distance to the sample center proportional to the uncertainty value.

By combining images produced with different RNG sequences, the rendering approximates a smooth rendering of the segmentation data in some embodiments.

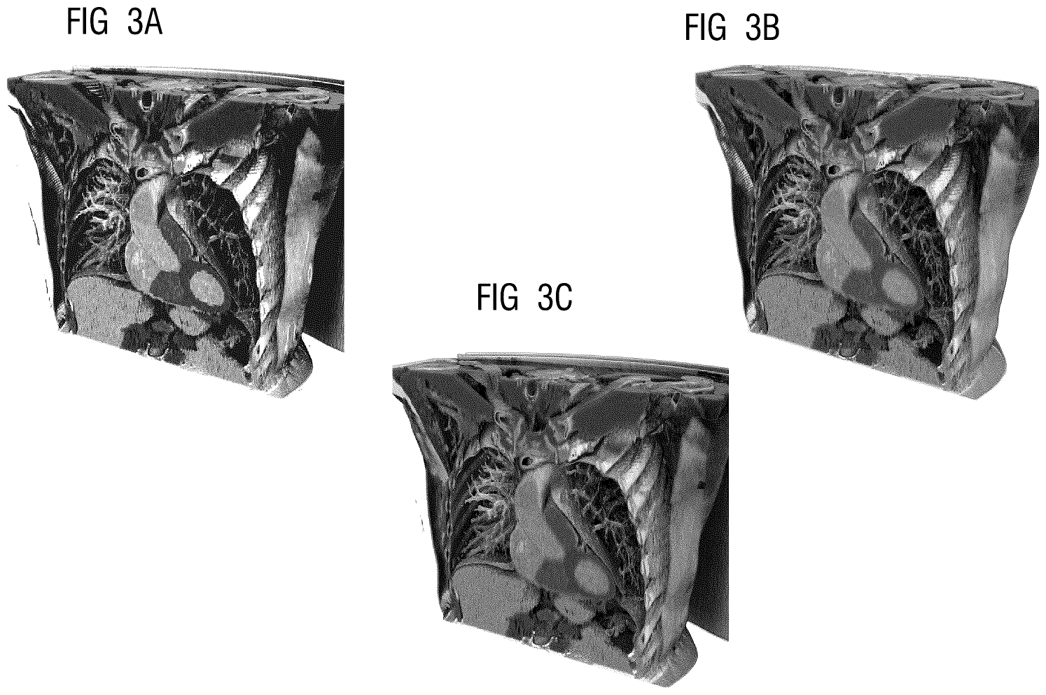

FIGS. 3A, 3B and 3C showcase a result with CT images acquired at 0.56 mm×0.56 mm×3 mm voxel resolution and overlapping masks for some of the segmentation classes. FIGS. 3A, 3B and 3C show a visual comparison of using higher order voxel reconstruction filtering and stochastic label map filtering. The anatomical structures displayed include a human thorax with lungs, heart chambers, major blood vessels and ribs visible.

In FIG. 3A, a trilinear voxel reconstruction is applied. In FIG. 3B, the trilinear voxel reconstruction is combined with stochastic label map sampling. FIG. 3C shows a higher-order voxel reconstruction filter for the anatomy data, namely a Cubic B-Spline voxel reconstruction, combined with stochastic label map sampling (and/or together with the stochastic label volume rendering). As visible in FIGS. 3A, 3B and 3C, the rendered volumes differ in terms of how sharp or smooth transitions among different anatomical structures are.

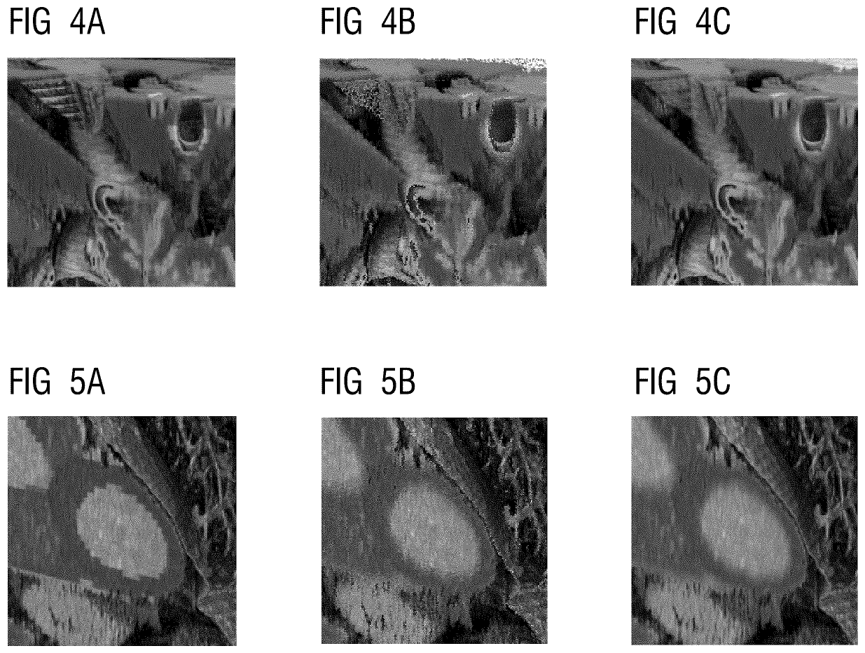

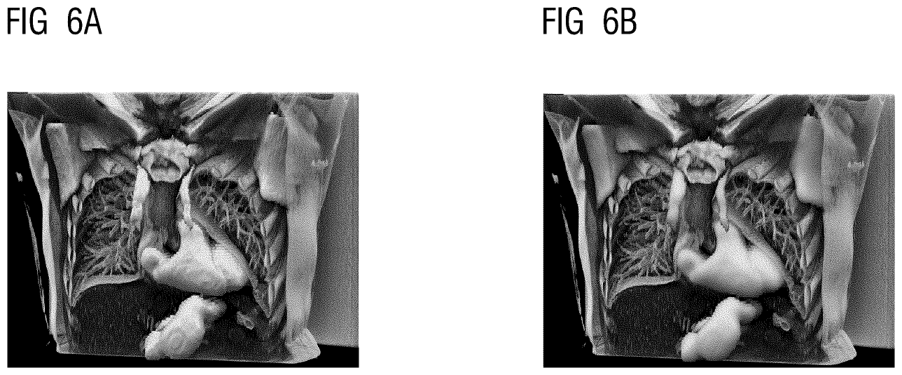

FIGS. 4A, 4B and 4C and FIGS. 5A, 5B and 5C focus on two different cropped regions (towards the upper left and lower right, respectively, of the anatomical structures displayed in FIG. 3B) and show the original rendering, an image with a single RNG seed, and the final accumulated result.

In FIGS. 4A, 4B and 4C, a clavicle extending from a back region of the volume and cut in a cross section at the front of the rendered volume is shown. A clear improvement in the visualization of distinct anatomical structures is visible when going from the single RNG seed image to the final accumulated result.

In FIGS. 5A, 5B and 5C, a cross section through a left ventricle (LV) endocardium and left ventricle (LV) epicardiumis shown as bright approximately oval shape and darker halo around the bright approximately oval shape, respectively. Again, a clear improvement in the visualization of the corresponding cardiac wall is visible when going from the single RNG seed image to the final accumulated result.

In both exemplary cases of the clavicles in FIGS. 4A, 4B and 4C as well as the LV endocardium and LV epicardium in FIGS. 5A, 5B and 5C, the important comparison of the technique is against the images without the uncertainty technique. E.g., going from FIG. 4A to 4C, the technique blends the label colors (which are displayed as different shades of gray in the accompanying drawings) and clearly identifies the volume of uncertainty.

Said differently, FIGS. 4A, 4B, 4C and 5A, 5B, 5C show different close-up views illustrating the stochastic sampling of the label map. All images use trilinear voxel reconstruction as in FIG. 3B. FIGS. 4A and 5A each show the original, FIGS. 4B and 5B each show the stochastic sampling and FIGS. 4C and 50 each show the accumulated result of the respective cropped region and/or close-up view.

Alternatively, or additionally, FIGS. 4A and 5A illustrate a conventional volume rendering without any uncertainty handling. In FIGS. 4B and 5B, the uncertainty-based label sampling (in particular, according to the technique, e.g., in the act S104 of the method 100) is applied. FIGS. 4B and 5B are re-rendered many times and averaged to reduce the variance in the image. The final denoised result is shown in FIGS. 4C and 5C.

For surface-based visualization of the segmentation data, the renderer in an exemplary embodiment employs subsurface scattering (SSS), which simulates the diffusion of light below the surface of the segmentation object. In a preferred embodiment and in lieu of a full lightpath simulation, the amount of SSS is controlled by a single radius value that determines a surface patch around the point where a light ray enters the surface.

Randomized sampling of the patch determines the light exit point with larger patches resulting in smoother surface shading. Accumulating the results from rendering with different RGN sequences results in smooth shading of the surface in the limit. Note that the geometry of the segmentation is not (or need not be) modified, and the SSS radius is proportional to the uncertainty measurement.

“In the limit” (in particular, as mathematical term) may describe the behavior (e.g., of the final rendering) as the number of accumulated samples approaches infinity. With infinite samples, the image variance would be 0 and there would be no noise. In practice, accumulating the results from rendering of different RGN sequences is stopped when the noise level is acceptable (e.g., below a predetermined threshold).

FIGS. 6A and 6B demonstrate an exemplary result with segmentation meshes generated by running the Marching Cubes algorithm and without additional processing of the geometry.

In FIGS. 6A and 6B, a direct rendering of segmentation meshes obtained via Marching Cubes of the label map is displayed. Stochastic SSS smoothes out visual surface artifacts (also denoted as smoothed shading) in FIG. 6B compared to smoothing the surface normals (briefly denoted as smoothed normal) only in FIG. 6A, without any modifications to the surface geometry. The effect is, e.g., visible when comparing the heart and stomach in each of FIGS. 6A and 6B.

The rendering technique may target two cases: offline rendering where many stochastic passes are accumulated to produce reference quality results, and realtime rendering without accumulation, which instead uses temporal image reconstruction to produce noise-free images.

In a preferred embodiment, deep learning-based image reconstruction is used, in particular using an interactive reconstruction of a Monte Carlo image sequence using a recurrent denoising autoencoder (e.g., including NVIDIA DLSS and/or Intel XeSS). Alternatively, or additionally, dedicated AI-based denoisers and/or temporal reprojection approaches may be used. In a simple embodiment, the accumulation of the stochastic passes is performed only when the user stops interacting with the system (e.g., including the computing device and, in particular, for realtime applications, the medical scanner), with the noisy images shown during interaction.

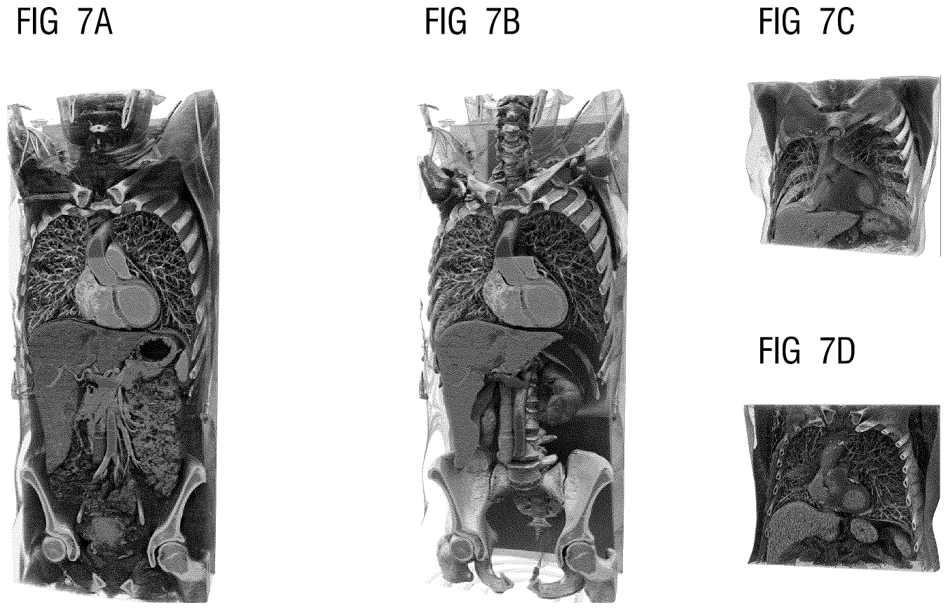

FIGS. 7A, 7B, 7C and 7D show exemplary results from additional higher resolution CT scans rendered using the technique.

FIGS. 7A and 7B and show a human torso with tinting structures and only segmented structures, respectively. FIGS. 7C and 7D show analogous images focused on the thorax displaying tinting structures and only segmented structures, respectively.

The technique can produce smooth shading without blocky artifacts at the boundaries of segmentation structures, e.g., as illustrated in FIGS. 7A to 7D. Furthermore, the sharpness of the color blending (as illustrated in different shades of gray, e.g., in FIGS. 7A to 7D) at the interfaces of the segmented structures provides a visual indication of the amount of uncertainty in the segmentation.

The described rendering technique can produce high quality 3D visualizations, in particular, with binary segmentation masks, without complex pre-processing of the data. Modern image reconstruction techniques can make the stochastic approach practical for realtime use and enable applications for realtime imaging modalities (e.g., CT), e.g., for surgical guidance.

The presence of the described algorithm may be detectable by rendering phantom data with crafted segmentation masks. Uncertainty may be introduced by applying a noise filter to the binary segmentation masks and examining the amount of smoothing in the optical color and opacity applied during rendering. The case of smoothed shading for mesh surfaces may, e.g., be detected by using image data with thick slices like in FIGS. 6A and 6B and evaluating for different stepping artifacts at surfaces parallel and perpendicular to the viewing direction.

SSS is conventionally used for physically-based modelling of materials, e.g., the scattering and absorption of light as it passes through human skin. By contrast, according to the technique, a non-physical property (in particular, an uncertainty according to the uncertainty indicator) may be mapped to SSS properties.

The uncertainty indicator (and/or uncertainty value) may be used to modulate the subsurface attenuation of one or more wavelength bands, e.g., by changing the radius of the patch for SSS sampling by different amounts based on both uncertainty (in particular, according to the uncertainty indicator) and color wavelength so that the shading in areas of high uncertainty both becomes smoother and picks up a red subsurface tint.

Wherever not already described explicitly, individual embodiments, or their individual aspects and features, described in relation to the drawings can be combined or exchanged with one another without limiting or widening the scope of the described invention, whenever such a combination or exchange is meaningful and in the sense of this invention. Advantages which are described with respect to a particular embodiment of present invention or with respect to a particular figure are, wherever applicable, also advantages of other embodiments of the present invention.

1. A computer-implemented method for volume rendering and/or surface rendering of a medical imaging data set based on optical properties per sampling points, the method comprising:
receiving an uncertainty indicator per voxel and/or per surface element in relation to a segmentation mask of and/or an anatomical structure comprised in the medical imaging data set;
scaling a randomization of one or more of the sampling points based on the received uncertainty indicator;
determining at least one optical property per sampling point as randomized; and
rendering a volume based on the voxels and/or a surface based on the surface elements, wherein the rendering is based on the determined at least one optical property per sampling point.

2. The method according to claim 1, wherein the received uncertainty indicator is based on a noise measurement within a local neighbourhood within the segmentation mask and/or across segmentation masks, and/or within the anatomical structure and/or across anatomical structures.

3. The method according to claim 1, wherein the received uncertainty indicator is determined by a segmentation algorithm, which provides the segmentation mask.

4. The method according to claim 1, wherein the scaling of the randomization comprises scaling a distance to a sample center as a function of the received uncertainty indicator.

5. The method according to claim 1, further comprising:
combining the at least one optical property of the more than one sampling points, wherein the rendering is based on the combined at least one optical property of the more than one sampling points.

6. The method according to claim 1, wherein the rendering comprises a denoising.

7. The method according to claim 6, wherein the denoising comprises using random number generator sequences for sampling the medical imaging data comprised in the medical imaging data set.

8. The method according to claim 1, wherein the medical imaging data set is acquired by a medical scanner, wherein the medical scanner comprises:
an X-ray device;
an ultrasound device;
a positron emission tomography device;
a computed tomography device;
a single-photon emission computed tomography device; or
a magnetic resonance tomography device.

9. The method according to claim 1, wherein the at least one optical property comprises at least one of:
an opacity;
a reflectance;
a color; and/or
at least one value indicative of a chromatic scattering.

10. The method according to claim 1, wherein the rendering comprises applying a reconstruction filter.

11. The method according to claim 1, wherein the rendering comprises ray casting, Monte Carlo path tracing, subsurface scattering, and/or rendering a color mesh.

12. The method according to claim 11, wherein the received uncertainty indicator is mapped to at least one property of the subsurface scattering.

13. The method according to claim 12, wherein a subsurface attenuation of one or more wavelength bands comprises the at least one property and is modulated according to the received uncertainty indicator.

14. The method according to claim 1, wherein, in the absence of a user interaction, for the rendering, multiple stochastic passes are accumulated and/or averaged over medical imaging data associated with different sampling points.

15. The method according to claim 1, wherein, in the presence of a user interaction, the rendering is performed without accumulating multiple stochastic passes and/or without averaging over the medical imaging data set associated with different sampling points;
wherein after a predetermined time period in which no user interaction is received, multiple stochastic passes are accumulated and/or averaged over medical imaging data set associated with different sampling points.

16. The method according to claim 1, wherein the rendering comprises rendering an inhomogeneous representation of the volume and/or of the surface comprising at least partially the segmentation mask and at least partially the anatomical structure.

17. A system for volume rendering and/or surface rendering of a medical imaging data set based on optical properties per sampling points, the system comprising:
a memory configured to store instructions; and
a processor configured to execute the instructions, the instructions comprising:
a receiving module configured for receiving an uncertainty indicator per voxel and/or per surface element in relation to a segmentation mask of and/or an anatomical structure comprised in the medical imaging data set;
a scaling module configured for scaling a randomization of one or more sampling points based on the received uncertainty indicator;
a determining module configured for determining at least one optical property per sampling point; and
a rendering module configured for rendering a volume based on the voxels and/or a surface based on the surface elements, wherein the rendering is based on the determined at least one optical property per sampling point.

18. A non-transitory computer-readable medium on which program elements are stored that can be read and executed by a computing device for rendering of medical imaging data based on optical properties per sampling points, the program elements comprising instructions to:
receive an uncertainty indicator per voxel and/or per surface element in relation to a segmentation mask of and/or an anatomical structure comprised in the medical imaging data set;
scale a randomization of one or more of the sampling points based on the received uncertainty indicator;
determine at least one optical property per sampling point as randomized; and
render a volume based on the voxels and/or a surface based on the surface elements, wherein the rendering is based on the determined at least one optical property per sampling point.
